(19) United States
(12) Patent Application Publication
(10) Pub. No.: US 2026/0073288 A1
(43) Pub. Date: Mar. 12, 2026

(54) EXECUTING NETWORK FUNCTIONS VIA CUSTOM LARGE LANGUAGE MODELS

(71) Applicant: AT&T Intellectual Property I, L.P., Atlanta, GA (US)

(72) Inventors: Joseph Soryal, Glendale, NY (US); Venson Shaw, Kirkland, WA (US); Jason V. Chang, Decatur, GA (US)

(21) Appl. No.: 18/884,060

(22) Filed: Sep. 12, 2024

(51) Int. Cl. G06N 20/00

(52) U.S. Cl. CPC G06N 20/00

(57) ABSTRACT

A processing system deployed in a cellular network may exchange communications with a network device for a predefined period of time, may generate a custom machine learning model based on messages contained in the communications, and may execute a network function on the processing system using the custom machine learning model for interacting with the network device.

The present disclosure relates generally to cellular networks, and more particularly to methods, non-transitory computer-readable media, and apparatuses for executing network functions via custom large language models.

### BACKGROUND

Machine learning models such as Large language models (LLMs) can be used for natural language processing and artificial intelligence (AI) technologies. LLMs can be used to allow users to interact with devices in a natural manner. For example, a user may simply talk naturally with a device as he or she would in every day conversations with another person to interact with and/or control the device. A library of terms can be used to train the LLMs over a period of time. The LLMs can be updated and evolve overtime to become more immersive for the user.

### SUMMARY

In one example, the present disclosure discloses a method, computer-readable medium, and apparatus for executing network functions via custom large language models. For example, a processing system including at least one processor deployed in a cellular network may exchange communications with a network device for a predefined period of time, may generate a custom machine learning model based on messages contained in the communications, and may execute a network function on the processing system using the custom machine learning model for interacting with the network device.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a block diagram of an example LLM module of the present disclosure;

FIG. 3 illustrates a block diagram of an example LLM module of a central server of the present disclosure;

FIG. 4 illustrates a flowchart of an example method for executing a network function via a custom LLM of the present disclosure;

FIG. 5 illustrates a flowchart of an example method for monitoring conversations between network devices of the present disclosure; and

FIG. 6 illustrates a high level block diagram of a computing device specifically programmed to perform the steps, functions, blocks and/or operations described herein.

To facilitate understanding, similar reference numerals have been used, where possible, to designate elements that are common to the figures.

### DETAILED DESCRIPTION

The present disclosure broadly discloses methods, non-transitory computer-readable media, and apparatuses for executing network functions via custom machine learning models, e.g., large language models. Currently, network devices may communicate with each other using known standard protocols to execute various network functions. The standard protocols may use programming languages or formats that are known and can be easily hacked. Thus, network security may be a concern.

For example, authentication functions may use a username and password, a pair of keys, and the like to authenticate a network device with another network device when accessing a network. The passwords and/or keys can be stolen.

As discussed above, machine learning models, e.g., large language models (LLMs) can be used for natural language processing and artificial intelligence (AI) technologies. LLMs can be used to allow users to interact with devices. For example, a library of terms can be used to train the LLMs over a period of time.

In addition, the LLMs can be updated and evolve overtime to become more immersive. However, the ability for the LLMs to evolve can create issues if the LLMs are allowed to evolve without constraints or coordination.

In accordance with the present disclosure, network devices may create a custom LLM that can be used between only the two devices that created and/or utilized the custom LLM. In other words, pairs of network devices can create their own custom LLM that is not used by other network devices in the network. This may make it difficult for the custom LLM to be hacked. The custom LLMs can be created over a period of time based on communications exchanged between the two network devices. The custom LLMs may be based on unique messages or words, or unique context around the communications that are not accessible by any other network devices within the network. The custom LLMs may eliminate the use of existing authentication methods that can be hacked or stolen. Rather, the network devices may simply “converse” with one another to perform various network functions in a secure way without additional security elements or procedures.

In one embodiment, the network device may monitor itself to ensure that the custom LLM does not evolve to a point that the custom LLM has gone “rogue” or undecipherable by a central server, i.e., the custom LLM's behavior has deviated from the expectation of the central server. In one embodiment, the central server may monitor all network devices to ensure that none of the custom LLMs developed by any of the network devices goes “rogue.” In one embodiment, a combination of self-monitoring by each network device and centralized monitoring by a central server may be deployed.

In addition, the central server may monitor all network devices and provide constraints with regard to how the custom LLMs can be created. For example, the central server may set a predefined time period for how long communications are to be exchanged between network devices to train the custom LLM and which communications are to be used for the training (e.g., a subset of the communications conveyed during the predefined time period). The central server may also set guidelines with respect to how many characters may be included in each “word” in the custom LLM, how many human readable words (e.g., words that use a combination of American Standard Code for Information Interchange (ASCII) text or numbers) can be used, whether a minimum or maximum number of human readable words is required, whether the custom LLM may include non-human readable words (e.g., audible tones, a range of frequencies for the audible tones, images, and/or a range of colors or patterns for the images), whether a minimum or maximum number of non-human readable words is required, and the like.

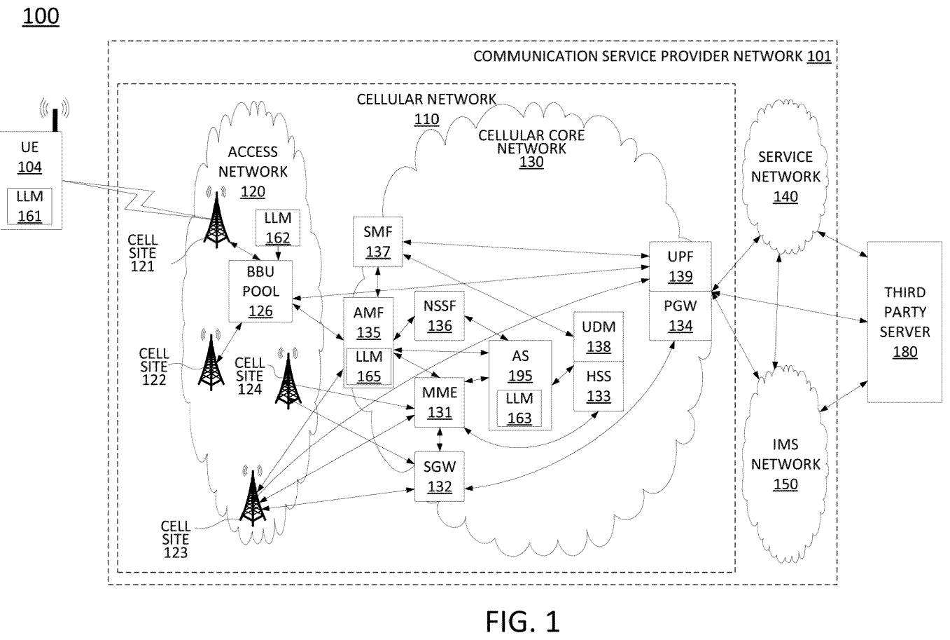

Furthermore, the central server may determine when the network devices should halt the use of the custom LLMs for encryption. For example, the central server may have an override switch or a “kill switch” that terminates the use of the custom LLMs if the network devices evolve the custom LLMs to a point where the central server no longer understands or deciphers the custom LLM that is being used between two network devices. This may prevent the custom LLM from evolving continuously, which can lead to the network devices becoming rogue and becoming a security threat to the network. These and other aspects of the present disclosure are described in greater detail below in connection with the examples of FIGS. 1-6.

FIG. 1 illustrates an example network, or system 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include a third party server 180 connected to the communication service provider network 101. In an example, the third party server 180 may be a commission on accreditation for law enforcement agencies (CALEA) server (e.g., an emergency 911 call center). As discussed in further details below, in some instances, the third party server 180 may request access to communications between network devices or elements that are encrypted with the custom LLM. As a result, an application server (AS) 195 (also referred to as the central server 195) may control a network element to halt use of the custom LLM, or may decrypt the encrypted communications before sending the communications to the third party server 180.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. Although FIG. 1 illustrates a BBU pool 126, it should be noted that each cell site 121 and 122 may have their own BBU. In other words, a single BBU may be deployed with each cell site 121 and 122 rather than deploying a BBU pool 126 assigned to multiple cell sites 121 and 122.

In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

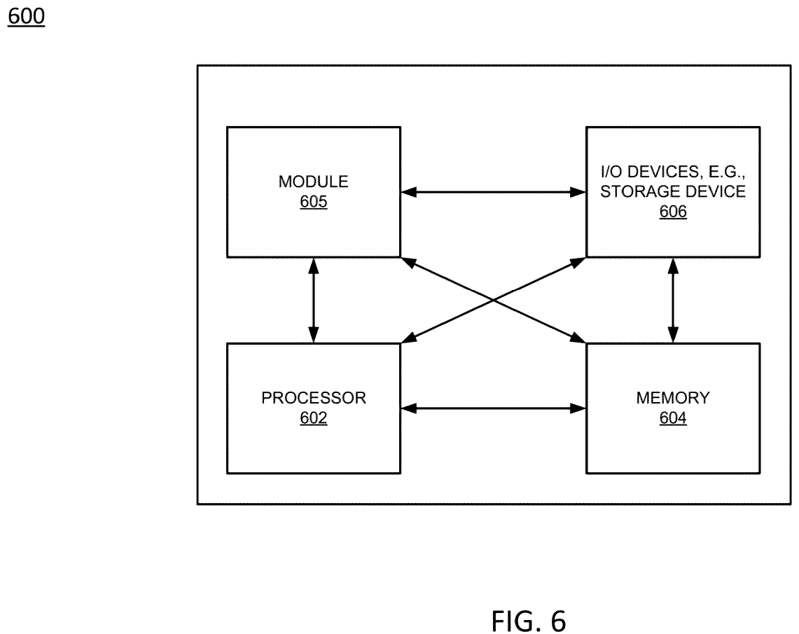

Any one or more of cell sites 121-123 may be deployed with antenna and radio infrastructures, including multiple input multiple output (MIMO) and millimeter wave antennas. Furthermore, a base station (e.g., cell sites 121-123 and/or baseband units within BBU pool 126) may comprise all or a portion of a computing system, such as computing system 600 as depicted in FIG. 6, and may be configured to perform steps, functions, and/or operations in connection with examples of the present disclosure.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In one embodiment, the cellular core network 130 may include the AS 195, which may also be referred as a central server 195. The central server 195 may monitor communications encrypted with the custom LLM between network devices. The central server 195 may provide a control signal to halt use of the custom LLM when the custom LLM evolves outside of the predefined parameters or constraints set by the central server 195, as discussed in further details below.

In one embodiment, the central server 195 may also provide translation or decryption services for the third party server 180. As noted above, the third party server 180 may be a CALEA server that requests access to communications from one of the network elements, such as a user endpoint (UE) 104. The central server 195 may decrypt communications that are encrypted by the custom LLM of the UE 104.

In addition, in the cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, networks associated with the third party server 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, the third party server 180 may be connected via other networks, such as an enterprise networks, a circuit switched network (e.g., a public switched telephone network (PSTN)), a cable network, a digital subscriber line (DSL) network, a metropolitan area network (MAN), an Internet service provider (ISP) network, and the like. In this regard, it should be noted that any one or more of service network 140, other networks associated with the third party server 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., the UE 104. UE 104 may comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In one example, the UE 104 may comprise all or a portion of a computing system, such as computing system 600 as depicted in FIG. 6, and may be configured to perform steps, functions, and/or operations in connection with examples of the present disclosure As illustrated in FIG. 1, UE 104 may include a large language model (LLM) module 161, the BBU 126 of the cell site 121 may include an LLM module 162, the central server 195 may include an LLM module 163, and the AMF 135 may include an LLM module 165. Although only four network devices are shown with LLM modules, it should be noted that more, or all, of the network devices may have their own LLM module. The LLM modules 161, 162, 163, and 165 may include one or more custom LLMs, as described in further details below. For example, each custom LLM may be deployed as an encryption module and a reverse/decryption module.

In addition, multiple custom LLMs may be deployed in each LLM module 161, 162, 163, and 165 depending on how many other network devices a network device may communicate with. For example, if the BBU 126 of the cell site 121 communicates with four other network devices, the LLM module 162 may include four different custom LLMs deployed as a pair of custom LLM encryption modules and reverse custom LLM modules.

In one embodiment, the UE 104 may communicate with the cell site 121 over a period of time. For example, the central server 195 may set a predefined period of three months to train the LLM 161 and the LLM 162, e.g., concurrently. Over the predefined period of time, the UE 104 and the cell site 121 may generate a custom or “custom trained” LLM based on unique text or contexts e.g., contained only in the communications over the three month time period between the UE 104 and the cell site 121.

For example, the UE 104 and the cell site 121 (or another UE (not shown in FIG. 1)) may exchange communications over the three month time period. The communications may include information including the amount of data transmitted from the UE 104 to the cell site 121, the frequency or bandwidth used to transmit messages on a regular basis, a number of messages that are transmitted on average per day, and the like. Overtime the UE 104 and the cell site 121 may develop a custom LLM that is based on the unique information associated with the communications between the UE 104 and the cell site 121. The custom LLM may then be stored as part of the LLM 161 and the LLM 162.

Subsequently after the LLM 161 and 162 are trained, the LLM 161 and LLM 162 can be used to execute a network function, such as an authentication function or an encryption function. For example, for authentication, instead of using a public and private key pair, the cell site 121 may provide a communication that includes an exact size of data transmitted on a particular day to the cell site 121. The information may be transmitted in a combination of audible tones and ASCII text that only the UE 104 and the cell site 121 may understand.

In another example, the UE 104 and the cell site 121 may exchange communications during the training period. The communications may include voice calls, text, emails, video, and the like. The communications may revolve around family members, favorite sports teams, vacations, and the like. In other words, the communications transmitted by the UE 104 to the cell site 121 may include unique information that only the UE 104 and the cell site 121 may know about. The custom LLM may be trained based on this unique information. The language used in the custom LLM may only include words included in the communications ever transmitted by the UE 104.

For example, communications from the UE 104 may have included names of family members Jane and John, sports teams such as Hurricanes, Phillies, and Wolverines, and vacation destinations comprising names of beaches, mountains, and islands. The custom LLM may have a library of words used in the communications with a key to provide a translation for each word used in the custom LLM. The custom LLM may create a language where the sentence “John Hurricanes beach” may be translated by the key to mean “I am UE XXXX providing authentication to cell site YYYY.” To a hacker, the sentence “John Hurricanes beach” may be unintelligible, but using the trained custom LLM the UE 104 and the cell site 121 may be able to decipher or decrypt the communications.

In another example, the UE 104 and the cell site 121 (or another UE) may exchange communications that include data from sensors. For example, the UE 104 may provide sensor data such as location, SSID of a Wi-Fi network, temperature, humidity, identification information associated with UE 104, processor utilization, memory usage, and the like. The UE 104 may receive sensor data from the cell site 121 as well. For example, the cell site 121 may provide sensor data such as location, identification number, temperature, humidity, processor utilization, memory usage, average throughput, capacity utilization, and the like. The UE 104 and the cell site 121 may then generate a custom LLM based on the sensor data.

It should be noted that any combination of the above examples can be used to generate the custom LLM. For example, a combination of the data that is transmitted, word or context within each message or communication, and/or sensor data may be used to generate the custom LLM.

As noted above, the custom LLM may be used to perform other network functions, such as authentication, operation improvements, or encrypting data. For example, if the UE 104 is on a busy frequency or bandwidth, the cell site 121 may send a control signal in the custom LLM to the UE 104 to change a connection to a different frequency (e.g., changing from 2.4 GHz channel on Wi-Fi to the 5.0 GHz channel).

In another example, the cell site 121 may have custom LLMs set up with other user endpoint devices. The cell site 121 may remember a particular application that improved compression for large amounts of data for another endpoint device. When the UE 104 attempts to transmit a large data file, the cell site 121 may use the custom LLM to send a control signal to automatically install the data compression application on the UE 104 and have the UE 104 use the data compression application to compress the large data file before transmitting the large data file. Thus, the custom LLM may be used to change a configuration or parameter setting on the UE 104 to improve operation of the UE 104 or the cell site 121.

In another example, once the UE 104 is authenticated to the network via the cell site 121, the UE 104 may encrypt all data using the custom LLM. The cell site 121 may then use a key for the custom LLM to decrypt the data or may pass the data along to a destination that may also have the custom LLM to decrypt the data.

In one embodiment, the cell site 121 may create a second custom LLM with another network device, such as the AMF 135. For example, LLM module 162 of the cell site 121 may be configured with multiple custom LLMs that can communicate with the LLM module 161 and the LLM module 165. For example, the cell site 121 may also exchange messages with the AMF 135 for a predefined period of time to train the custom LLM used between the cell site 121 and the AMF 135. The custom LLM used between the cell site 121 and the AMF 135 may be different than the custom LLM used between the cell site 121 and the UE 104.

The communications exchanged between the cell site 121 and the AMF 135 may include unique messages or context that is not included between the communications exchanged between the cell site 121 and the UE104. For example, the cell site 121 and the AMF 135 may only exchange messages that include various machine code or programming languages. Thus, unique content within these messages may be used to train the custom LLM used by the LLM module 162 and the LLM module 165. The custom LLM developed for the LLM module 162 and the LLM module 165 may then be used to execute a second network function between the cell site 121 and the AMF 135.

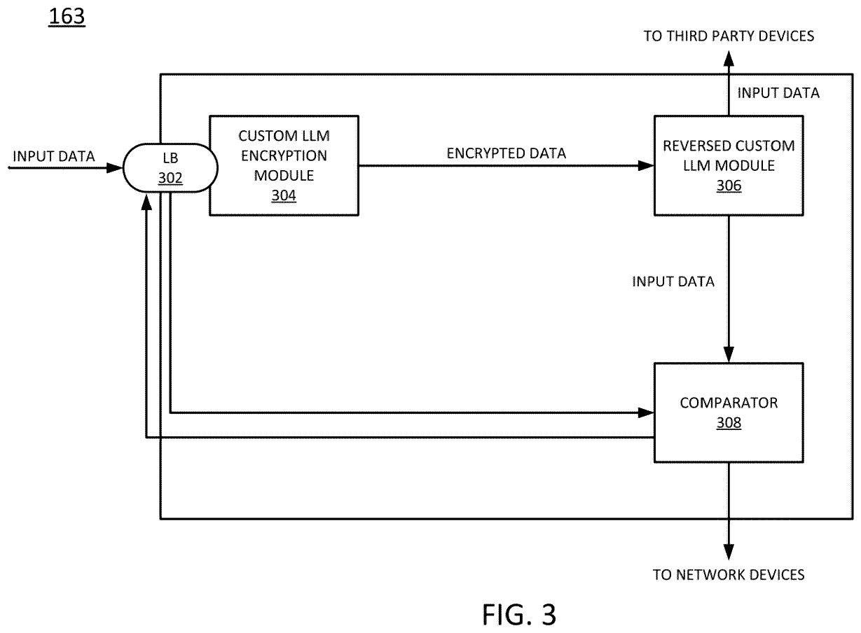

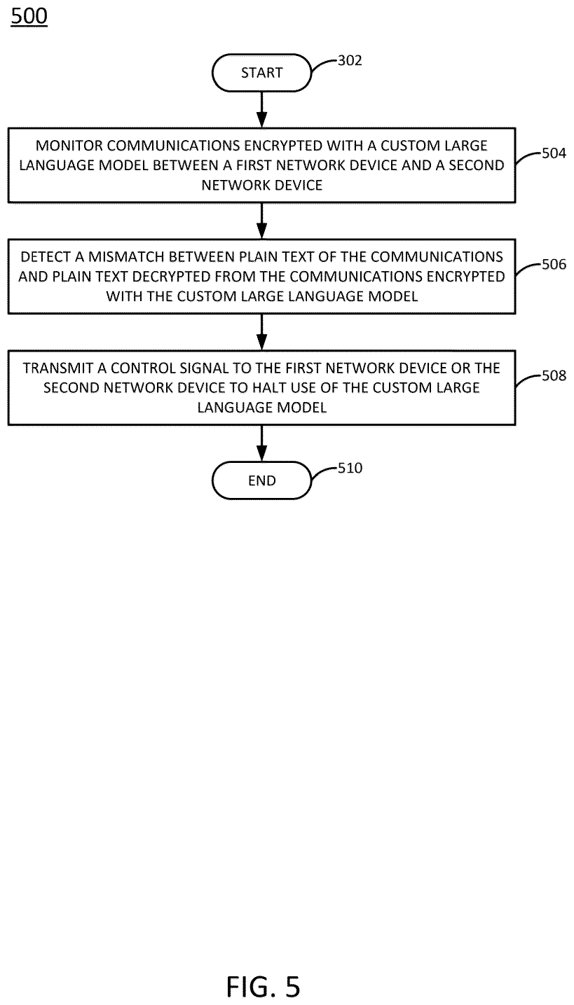

The custom LLMs developed by the various network devices may all be transmitted to the central server 195 for monitoring purposes, as discussed in further details below with respect to FIG. 3 and FIG. 5. After the custom LLMs are initially set, the custom LLMs may bet set to establish a key to decrypt any encrypted messages exchanged between any two network devices. As the custom LLMs evolve between these two network devices, the evolved custom LLMs may also be periodically transmitted to the central server 195 for monitoring. However, the key to decipher encrypted communications may be set with the initial custom LLM that was developed after the first training period between two network devices.

Thus, the central server 195 may monitor the custom LLMs, to ensure that the custom LLMs do not evolve to a point of being “rogue,” and the central server 195 can send control signals to particular network devices that have “rogue” custom LLMs to halt use of the “rogue” custom LLMs. The central server 195 may also send control signals to the network devices to retrain or reset the “rogue” custom LLMs and to create updated custom LLMs that fall back within the constraints and/or parameters set by the central server 195.

In one embodiment, the central server 195 may also provide “translation services” for the third party server 180. For example, the third party server 180 may be on a competitor network that does not use the custom LLMs. The UE 104 may be trying to communicate with the third party server 180. The UE 104 may still use the custom LLM to encrypt the data that is transmitted. The central server 195 having acquired the custom LLM from the UE 104 may then decrypt the encrypted data before transmitting the data to the third party server 180.

In one embodiment, the central server 195 may also send an over-ride control signal to a particular network device to turn the custom LLM on and off. Thus, when the request from the third party server 180 is received the central server 195 may transmit the over-ride control signal to the network device with the communications that the third party server 180 is requesting to stop encryption with the custom LLM. The network device may then send the unencrypted communication to the third party server 180. After the request is completed, the central server 195 may then send another control signal to the network device to re-activate the custom LLM. Thus, the custom LLM encryption/decryption may be provided as a subscription service to other network devices or elements outside of the communication service provider network 101.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of cell sites 121-123 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

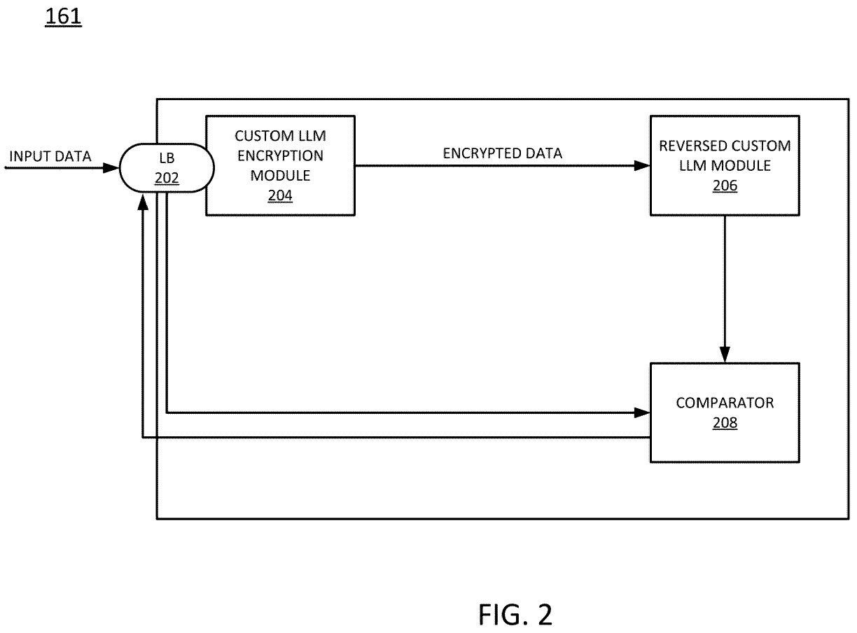

To aid in understanding the present disclosure, FIG. 2 illustrates a block diagram of the LLM module 161. FIG. 2 may also represent the LLM 162, the LLM 165 or any other LLMs, other than the LLM 163 illustrated in FIG. 3 and discussed in further detail below, that may be included in the other network devices or elements in the access network 120 and the cellular core network 130.

In an example, the LLM module 161 may include a self-monitoring loop to ensure that the custom LLM does not evolve to a point that cannot be controlled by the central server 195. For example, the LLM module 161 may include a load balancer (LB) 202, a custom LLM encryption module 204, a reversed custom LLM module 206, and a comparator 208. As noted above, the LLM module 161 may be trained with a custom LLM. The custom LLM encryption module 204 may include the current status of the custom LLM developed between the UE 104 and the cell site 121. The reversed custom LLM module 206 may include a key or the definitions for terms, symbols, images, audio tones, and the like that were set during after the first training period was completed for the custom LLM.

The key or definitions of the reversed custom LLM module 206 are fixed and do not change over time. However, the custom LLM used between the UE 104 and the cell site 121 may evolve over time. Thus, the custom LLM encryption module 204 may change dynamically over time as the custom LLM evolves.

In one example, input data may be fed to the LLM module 161. The input data may be any type of data, including a voice call, text messages, emails, images, videos, and the like. The input data may be fed to the LB 202 and the custom LLM encryption module 204. The input data may also be fed directly from the LB 202 without encryption to the comparator 208. The custom LLM encryption module 204 may encrypt the input data with the custom LLM and feed the encrypted input data to the reversed custom LLM module 206. The reversed custom LLM module 206 may decrypt the encrypted data back to the original form of the input data and feed the input data to the comparator 208.

The comparator 208 may then compare the input data received directly from the LB 202 and the decrypted input data received from the reversed custom LLM module 206. If the two input data match, then the LLM module 161 is operating properly and may continue to use the custom LLM. However, if the two input data do not match, then the custom LLM may have evolved outside of the allowable parameters or constraints set by the central server 195. As a result, the comparator 208 may send a control signal back to the LB 202 to halt the use of the custom LLM encryption module 204 or the custom LLM used by the LLM module 161.

The central server 195 may also be notified by the LLM module 161 via the UE 104 that the custom LLM encryption module 204 has gone “rogue” (or deviated from an acceptable norm) and operation has been halted. In response, the central server 195 may then instruct the UE 104 and the cell site 121 to execute a training procedure again over the predefined time period to reset the custom LLM in accordance with the parameters or constraints set by the central server 195.

FIG. 3 illustrates a block diagram of an LLM module 163 that may be part of the central server 195. The LLM module 163 may be slightly different than the LLM modules 161,162, or 165 deployed on the network devices or elements. Although a single custom LLM encryption module 304 and a single reversed custom LLM module 306 is illustrated in FIG. 1, the LLM module 163 may include a custom LLM encryption module 304 for every network element or device (or every set of network elements or devices) that is being monitored. Similarly, the LLM module 163 may include a reversed custom LLM module 306 for every network element or device (or every set of network elements or devices) that is being monitored. In other words, the LLM module 163 may include multiple instances of the custom LLM encryption module 304 and multiple instances of the reversed custom LLM module 306.

As discussed above, the reversed custom LLM module 306 may be fixed and may not change over time. The custom LLM encryption module 304 may be periodically updated with the custom LLM encryption module 204 from the other network device LLM modules 161, 162 and 165. Thus, the central server 195 may monitor the custom LLM activity of all network devices or elements within the system 100.

Similar to the LLM module 161 illustrated in FIG. 2, the LLM module 163 may have a load balancer (LB) 302. The input data may be fed to the LB 302. The input data for the LLM module 163 may indicate which network device transmitted the input data. The central server 195 may then apply the pertinent custom LLM encryption module 304 and reversed custom LLM module 306 for that particular network device.

The input data may be forwarded to a comparator 308 and the custom LLM encryption module 304 for encryption. The reversed custom LLM module 306 may decrypt the encrypted data and the decrypted input data may be fed to the comparator 308. The comparator 308 may then determine if the two input data match. If the two input data match, then the custom LLM for the particular network device that transmitted the input data may be operating properly. If the two input data do not match, then the custom LLM may have gone “rogue” and the central server 195 may transmit a control signal to the network device to halt use of the custom LLM. The central server 195 may further instruct the network device to re-execute a custom LLM training process to reset the custom LLM for the particular network device.

In one embodiment, the central server 195 may include an override switch/control signal for the third party server 180. For example, the third party server 180 may be outside of the communication service provider network 101 and not have access to the custom LLMs used by the network devices within the communication service provider network 101. The third party server 180 may be a CALEA server that requests access to communications from the UE 104 during an emergency. The central server 195 may initiate an override to a particular network device in response to the request from the third party server 180 and use the reversed custom LLM Module 206 of the network device to decrypt input data from the UE 104. The decrypted input data may then be transmitted to the third party server 180 (e.g., a CALEA server).

In another example, the central server 195 may provide translation for the third party server 180. For example, the encrypted data may arrive at the central server 195. The central server 195 may then apply the reversed custom LLM module 306 associated with the network device that transmitted the encrypted data to decrypt the data. The decrypted data may then be transmitted to the third party server 180 to fulfill the request.

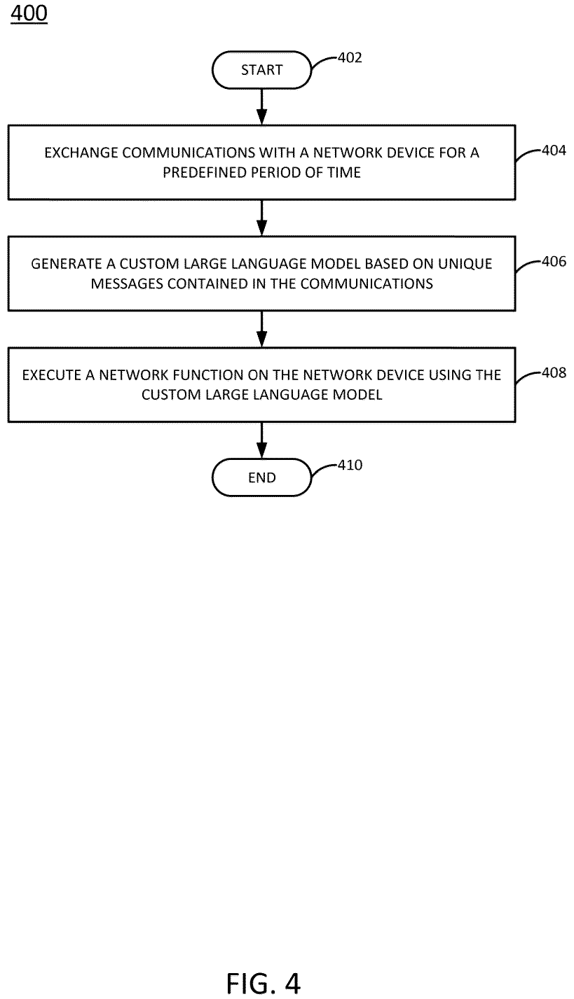

FIG. 4 illustrates a flowchart of an example method 400 for executing a network function via a custom LLM, in accordance with the present disclosure. In one example, steps, functions and/or operations of the method 400 may be performed by a device as illustrated in FIG. 1, e.g., any of the UE 104, AS 195, SMF 137, MME 131, NSSF 136, AMF 135, UPF 139, PGW 134, and so forth, or the BBU 126 of the cell sites 121-124, or any one or more components thereof, such as a processing system, or collectively via a plurality devices in FIG. 1, such as any one or more of AS 195, SMF 137, MME 131, NSSF 136, AMF 135, or the BBU 126 of the cell sites 121-124 in conjunction with another of such components, or one or more other entities, such a network repository function, and so forth. In one example, the steps, functions, or operations of method 400 may be performed by a computing device or system 600, and/or a processing system 602 as described in connection with FIG. 6 below. Similarly, in one example, the steps, functions, or operations of method 400 may be performed by a processing system comprising one or more computing devices collectively configured to perform various steps, functions, and/or operations of the method 400. For instance, multiple instances of the computing device or processing system 600 may collectively function as a processing system. For illustrative purposes, the method 400 is described in greater detail below in connection with an example performed by a processing system, such as processing system 602.

The method 400 begins in step 402. At step 404, the processing system may exchange communications with a network device for a predefined period of time. For example, a UE and a BBU of a cell site or RAN may exchange communications over a predefine period of time, e.g., a three month time period, defined by a central server. The communications may include information including the amount of data transmitted from the UE to the cell site, the frequency or bandwidth used to transmit messages on a regular basis, a number of messages that are transmitted on average per day, and the like. Overtime the UE and the cell site may develop a custom LLM that is based on the unique information associated with the communications between the UE and the cell site, where the custom LLM is solely used for interaction between the UE and the cell site. The custom LLM may then be stored as part of the LLM modules associated with the UE and the cell site, where this custom LLM is accessible by the UE, the cell site and the central server.

In another example, the communications may include voice calls, text, emails, video, and the like. The communications may revolve around family members, favorite sports teams, vacations, and the like. In other words, the communications transmitted by the UE to the cell site may include unique information that only the UE and the cell site may know about. The custom LLM may be trained based on this unique information. The language used in the custom LLM may only include words included in the communications ever transmitted by the UE.

At step 406, the processing system may generate a custom large language model (LLM) based on unique messages contained in the communications. For example, given the above examples the communications from the UE may have included names of family members Jane and John, sports teams such as Hurricanes, Phillies, and Wolverines, and vacation destinations of beaches, mountains, and islands. The custom LLM may have a library of words used in the communications with a key to provide a translation for each word used in the custom LLM. The custom LLM may create a language where the sentence “John Hurricanes beach” may be translated by the key to mean “I am UE XXXX providing authentication to cell site YYYY.” To a hacker, the sentence “John Hurricanes beach” may be unintelligible, but using the trained custom LLM the UE and the cell site may be able to decipher or decrypt the communications.

In one embodiment, the custom LLM can be transmitted to the central server to generate a key to the custom LLM for monitoring subsequent communications between the UE and the cell site that use the custom LLM.

At step 408, the processing system may execute a network function on the processing system (and the network device respectively) using the custom LLM for interacting with the network device. For example, the network function may be an authentication function, improving an operation of the processing system or the network device, improving operational efficiency, or an encryption function.

In an embodiment, the custom LLM may continue to evolve over time. The central server may monitor communications between the processing system and the network device. For example, the central server may receive input data or plain text from a network device. The central server may have a custom LLM encryption module and a reversed custom LLM module associated with the network device. The central server may periodically check to see if the input data or plain text received from the network device matches the input data or plain text that is encrypted and then decrypted to see if there is a mismatch. If a mismatch is detected, the central server may determine that the custom LLM has gone “rogue.”

In response, the processing system may receive a control signal from the central server to halt use of the custom LLM when the input data or plain text of the subsequent communications encrypted and decrypted with the custom LLM fail to match the input data or plain text that is not encrypted with the custom LLM. The processing system may further receive a control signal from the central server to repeat the training process by exchanging communications with the network device for another predefined period of time to generate an updated custom LLM that falls back in-line with the parameters and constraints for the custom LLM set by the central server. At step 410, the method 400 ends.

FIG. 5 illustrates a flowchart of an example method 500 for monitoring conversations between network devices, in accordance with the present disclosure. In one example, steps, functions and/or operations of the method 500 may be performed by the AS or central server 195. In one example, the steps, functions, or operations of method 500 may be performed by a computing device or system 600, and/or a processing system 602 as described in connection with FIG. 6 below. Similarly, in one example, the steps, functions, or operations of method 500 may be performed by a processing system comprising one or more computing devices collectively configured to perform various steps, functions, and/or operations of the method 500. For instance, multiple instances of the computing device or processing system 600 may collectively function as a processing system. For illustrative purposes, the method 500 is described in greater detail below in connection with an example performed by a processing system, such as processing system 602.

The method 500 begins in step 502. At step 504, the central server may monitor communications encrypted with a custom large language (LLM) between a first network device and a second network device. For example, the central server may receive input data or plain text from a network device. The central server may have a custom LLM encryption module and a reversed custom LLM module associated with the network device. The central server may periodically check to see if the plain text received from the network device matches the plain text that is encrypted, and then decrypted, to see if there is a mismatch.

At step 506, the central server may detect a mismatch between plain text of the communications and plain text decrypted from the communications encrypted with the custom LLM. If a mismatch is detected, then the central server may determine that the custom LLM has gone “rogue” (e.g., deviated from an expected normal operation). In other words, the latest version of the custom LLM encryption module received from the network device can no longer be decrypted by the reversed custom LLM module that was set when the custom LLM was initially trained.

At step 508, the central server may transmit a control signal to the first network device and/or the second network device to halt use of the custom large language model. In one embodiment, the central server may also transmit a control signal to the first network device and/or the second network device to repeat the training process by exchanging communications with the network device for the predefined period of time to generate an updated custom LLM that falls back in-line with the parameters and constraints for the custom LLM set by the central server. At step 510, the method 500 ends.

Although not specifically specified, one or more steps, functions, or operations of the example methods 400 and 500 may include a storing, displaying, and/or outputting step as required for a particular application. In other words, any data, records, fields, and/or intermediate results discussed in the method(s) can be stored, displayed, and/or outputted either on the device executing the method or to another device, as required for a particular application. Furthermore, steps, blocks, functions or operations in FIGS. 4 and 5 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 6 depicts a high-level block diagram of a computing device or processing system specifically programmed to perform the functions described herein. For example, any one or more components or devices illustrated in FIG. 1, or described in connection with the examples of FIGS. 2 and 3, respectively, may be implemented as the processing system 600. As depicted in FIG. 6, the processing system 600 comprises one or more hardware processor elements 602 (e.g., a microprocessor, a central processing unit (CPU) and the like), a memory 604, (e.g., random access memory (RAM), read only memory (ROM), a disk drive, an optical drive, a magnetic drive, and/or a Universal Serial Bus (USB) drive), a module 605 for executing a network function via a custom LLM, and various input/output devices 606, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like). In accordance with the present disclosure input/output devices 606 may also include antenna elements, antenna arrays, remote radio heads (RRHs), baseband units (BBUs), transceivers, power units, and so forth.

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 602 can also be configured or programmed to cause other devices to perform one or more operations as discussed above. In other words, the hardware processor 602 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 605 for executing a network function via a custom LLM (e.g., a software program comprising computer-executable instructions) can be loaded into memory 604 and executed by hardware processor element 602 to implement the steps, functions or operations as discussed above in connection with the example methods 400 or 500. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for executing a network function via a custom LLM (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
exchanging, by a processing system including at least one processor deployed in a cellular network, communications with a network device for a predefined period of time;
generating, by the processing system, a custom machine learning model based on messages contained in the communications; and
executing, by the processing system, a network function on the processing system using the custom machine learning model for interacting with the network device.

2. The method of claim 1, further comprising:
exchanging, by the processing system, a second set of communications with a second network device for the predefined period of time;
generating, by the processing system, a second custom machine learning model based on messages contained in the second set of communications, wherein the second custom machine learning model is different than the custom machine learning model associated with the network device; and
executing, by the processing system, a second network function on the processing system using the second custom machine learning model for interacting with the second network device.

3. The method of claim 1, wherein the network function comprises authenticating the network device using the custom machine learning model.

4. The method of claim 1, wherein the network function comprises improving an operation of the network device using the custom machine learning model.

5. The method of claim 1, wherein the network function comprises encrypting data exchanged with the network device using the custom machine learning model.

6. The method of claim 5, further comprising:
receiving, by the processing system, a request from a third party server to receive a subsequent communication between the processing system and the network device; and
decrypting, by the processing system, the subsequent communication before transmitting the subsequent communication to the third party server.

7. The method of claim 6, wherein the third party server comprises a commission on accreditation for law enforcement agencies server.

8. The method of claim 1, further comprising:
transmitting, by the processing system, the custom machine learning model to a central server to generate a key to the custom machine learning model for monitoring subsequent communications between the processing system and the network device that use the custom machine learning model.

9. The method of claim 8, further comprising:
receiving, by the processing system, a control signal from the central server to halt use of the custom machine learning model when plain text of the subsequent communications encrypted with the custom machine learning model that is decrypted using the key fail to match the plain text that is not encrypted with the custom machine learning model.

10. The method of claim 9, further comprising:
receiving, by the processing system, a control signal from the central server to repeat the exchanging communications with the network device for another predefined period of time to generate an updated custom machine learning model.

11. The method of claim 1, wherein the predefined period of time is set by a central server.

12. The method of claim 1, wherein the generating the custom machine learning model is performed within a set of constraints set by a central server, wherein the custom machine learning model comprises a custom large language model, and wherein the custom large language model is solely used for interacting with the network device.

13. The method of claim 12, wherein the set of constraints comprises at least one of: a length of each word, a maximum number of non-human readable words that can be used, a minimum number of human readable words that must be used, or a reset time frequency.

14. The method of claim 1, wherein the processing system comprises at least one of: a user endpoint device, a radio access network, a user plane function, or an authentication server.

15. A non-transitory computer-readable medium storing instructions which, when executed by a processing system including at least one processor deployed in a cellular network, cause the processing system to perform operations, the operations comprising:
exchanging communications with a network device for a predefined period of time;
generating a custom machine learning model based on messages contained in the communications; and
executing a network function on the processing system using the custom machine learning model for interacting with the network device.

16. The non-transitory computer-readable medium of claim 15, wherein the operations further comprise:
exchanging a second set of communications with a second network device for the predefined period of time;
generating a second custom machine learning model based on messages contained in the second set of communications, wherein the second custom machine learning model is different than the custom machine learning model associated with the network device; and
executing a second network function on the processing system using the second custom machine learning model for interacting with the second network device.

17. The non-transitory computer-readable medium of claim 15, wherein the operations further comprise:
transmitting the custom machine learning model to a central server to generate a key to the custom machine learning model for monitoring subsequent communications between the processing system and the network device that use the custom machine learning model.

18. The non-transitory computer-readable medium of claim 17, wherein the operations further comprise:
receiving a control signal from the central server to halt use of the custom machine learning model when plain text of the subsequent communications encrypted with the custom machine learning model that is decrypted using the key fail to match the plain text that is not encrypted with the custom machine learning model.

19. The non-transitory computer-readable medium of claim 18, wherein the operations further comprise:
receiving a control signal from the central server to repeat the exchanging communications with the network device for another predefined period of time to generate an updated custom machine learning model.

20. An apparatus comprising:
a processing system including at least one processor; and
a non-transitory computer-readable medium storing instructions which, when executed by the processing system when deployed in a cellular network, cause the processing system to perform operations, the operations comprising:
exchanging communications with a network device for a predefined period of time;
generating a custom machine learning model based on messages contained in the communications; and
executing a network function on the processing system using the custom machine learning model for interacting with the network device.
